(19) United States
(12) Patent Application Publication
(10) Pub. No.: US 2026/0340654 A1
(43) Pub. Date: Oct. 29, 2026

(54) METHOD FOR CALCULATING CARBON EMISSIONS BASED ON POWER CONSUMPTION OF SEMICONDUCTOR PRODUCTS

(71) Applicant: SK hynix Inc., Icheon-si (KR)

(72) Inventors: Kyu-jin Choi, Icheon-si (KR); Hyuk-hwa Kwon, Icheon-si (KR)

(21) Appl. No.: 19/402,241

(22) Filed: Nov. 26, 2025

(30) Foreign Application Priority Data
Apr. 28, 2025 (KR) 10-2025-0055244

(51) Int. Cl. G06Q 30/018

(52) U.S. Cl. CPC G06Q 30/018

(57) ABSTRACT

A life cycle assessment (LCA) method and a carbon emission calculation method based on the reduction of power consumption of semiconductor products are disclosed, and more particularly, a technology for quantitatively calculating the amount of power consumption reduction resulting from performance improvement and manufacturing process advancement of DRAM and NAND semiconductor products, and converting it into carbon emissions to compare and evaluate environmental impacts, is described.

### CROSS-REFERENCE TO RELATED APPLICATIONS

The present application claims priority under 35 U.S.C. § 119(a) to Korean application number 10-2025-0055244, filed on Apr. 28, 2025, in the Korean Intellectual Property Office, which is incorporated herein by reference in its entirety.

### BACKGROUND

### 1. Technical Field

The present disclosure relates to a life cycle assessment (LCA) method and a carbon emission equivalents calculation method based on the reduction of power consumption of semiconductor products, and more particularly, to a technology for quantitatively calculating the amount of power consumption reduction resulting from performance improvement and manufacturing process advancements pertaining to DRAM and NAND semiconductor products, and converting it into carbon emissions equivalents to compare and evaluate environmental impacts.

### 2. Related Art

Recently, as digital transformation centered around advanced technologies such as artificial intelligence (AI), big data, and cloud computing accelerates, the amount of information stored and processed in data centers is increasing. The data centers are continuously expanding to process such large-scale data at high speed, and their growth is expected to accelerate further in the future. Accordingly, there is a growing technical demand to improve the efficiency of data center operations and to reduce power consumption.

Companies that operate data centers are demanding semiconductor products that operate faster and consume less power than existing products. This demand is part of efforts to reduce the operational costs of data centers and to meet increasingly stringent global carbon emission regulations and environmental protection goals. However, there are various difficulties in accurately converting the actual power consumption reduction effects of DRAM or NAND products used in data centers into carbon emissions equivalents. This is because multiple variables need to be considered, such as the amount of product used in the data center, data storage conditions, usage temperature, and usage time. In particular, it is practically impossible to precisely calculate carbon emissions equivalents for semiconductor products because companies operating data centers do not provide the necessary information with enough detail.

On the other hand, data sheet specifications of DRAM or NAND products provided by semiconductor manufacturers contain objective and standardized information such as product characteristics, usage test conditions, density, number of I/Os, operating speed, operating voltage, and power consumption. Since this information is prepared in compliance with the standards established by JEDEC, the global semiconductor standards organization, the information may be used for comparison and evaluation among various semiconductor products.

Therefore, there is a need to develop a systematic calculation method that can accurately and efficiently calculate carbon emissions equivalents using the specifications of semiconductor products. This will greatly contribute to companies' compliance with environmental regulations and the fulfillment of their social responsibilities. As used herein, a carbon emissions equivalent for a semiconductor product means the carbon emission impact of the materials used in the manufacture of the semiconductor product, and carbon emissions equivalent and carbon emissions may be used interchangeably when referring to a semiconductor product.

### SUMMARY

The present disclosure has been devised to solve the above problems, and an objective of the present disclosure is to provide a method for quantitatively evaluating power consumption reduction effects resulting from technological advancements in design and manufacturing processes in DRAM and NAND semiconductor products, and for calculating and comparing carbon emissions based on this evaluation.

Further, an objective of the present disclosure is to provide a method for easily estimating and quantitatively demonstrating the improvement in power efficiency and the carbon emission reduction effects of semiconductor products in large-scale power consumption environments such as data centers.

Further, an objective of the present disclosure is to provide a method for comparing carbon emissions of an existing DRAM or NAND product with those of a technologically advanced DRAM or NAND product using data sheet specifications for a semiconductor product, and for quantitatively evaluating an extent to which technological advancement contributes to environmental protection and sustainability.

According to an embodiment of the present disclosure, a method for calculating carbon emissions based on power consumption reduction of a semiconductor product may include inputting monthly cumulative product sales of the semiconductor product; reflecting speed or density information of the semiconductor product; inputting annual usage time of the semiconductor product; converting an annual read or write processing data amount of the semiconductor product used in a server into a unit basis; and calculating carbon emissions based on power consumption of the semiconductor product.

When the semiconductor product is a DRAM product, the method may further include reflecting a number of I/Os of the DRAM product; and inputting a ratio of a read processing data amount (IDD4R) of the DRAM product. When the semiconductor product is a NAND product, the method may further include reflecting DWPD (Drive Writes Per Day) of the NAND product.

In the case of the DRAM product, the converting of the annual read processing data amount of the semiconductor product used in the server into the unit basis may perform calculation by multiplying monthly cumulative product sales, speed information, number of I/Os, and IDD4R ratio of the DRAM product by a time conversion value for calculating annual data processing volume. In the case of the NAND product, the converting of the annual write processing data amount of the semiconductor product used in the server into the unit basis may perform calculation by multiplying monthly cumulative product sales, density information, and DWPD of the NAND product by a time conversion value for calculating annual data processing volume.

Further, when calculating the carbon emissions of the DRAM product, calculation may be based on power consumption (pJ/bit) of the DRAM product, and the calculating of the power consumption (pJ/bit) of the DRAM product may include reflecting IDD power consumption, IDDQ power consumption, and IPP power consumption in a specific mode of the DRAM product; calculating a sum of power consumption by multiplying the IDD power consumption by VDD operating voltage, the IDDQ power consumption by VDDQ operating voltage, and the IPP power consumption by VPP operating voltage; and calculating the power consumption (pJ/bit) by dividing the sum of the power consumption by the operating speed and number of I/Os of the DRAM product.

When calculating the carbon emissions of the NAND product, calculation may be based on power consumption (J/GB) of the NAND product, and the calculating of the power consumption (J/GB) of the NAND product may include reflecting write power consumption of the NAND product; and calculating the power consumption (J/GB) by dividing the reflected write power consumption by sequential write performance of the NAND product.

The carbon emission reduction of the DRAM or NAND product may be calculated by subtracting improved-performance product emissions and leakage emissions from baseline product emissions. When the baseline product is GDDR5, DDR4, or 72-layered eSSD, the improved-performance product may use HBM2/HBM2E, DDR5, or 96-layered/128-layered eSSD.

The method may further include loading specification data of the semiconductor product, prior to the inputting of the monthly cumulative product sales, and the specification data of the semiconductor product may include product characteristics, usage test conditions, density, number of I/Os, operating speed, operating voltage, power consumption, and DWPD. In the calculating of the carbon emissions, the international standard emission factor (tCO₂-eq/MWh) may be used to convert the power consumption of the semiconductor product into carbon emissions (tCO₂-eq).

A method for calculating carbon emissions of a semiconductor product according to the present disclosure can easily calculate carbon emissions based on power consumption reduction by utilizing objective data provided in the Data sheet spec of the semiconductor product, such as power consumption, operating voltage, operating speed, and number of I/Os.

Further, the present disclosure utilizes Data sheet spec data that complies with JEDEC standards, allowing power consumption reduction and carbon emissions to be calculated based on highly reliable data. Since standardized data provided for all semiconductor products is used, it is also possible to make objective and fair comparisons between various products.

Furthermore, the present disclosure can quantitatively analyze power consumption reduction effects due to the development of semiconductor technology, and quantitatively evaluate an extent to which the power consumption reduction effects contribute to carbon emission reduction, thereby providing a quantitative basis for a company's carbon reduction activities.

### BRIEF DESCRIPTION OF THE DRAWINGS

FIG. 1 is a flowchart illustrating a method for calculating carbon emissions of a semiconductor product according to an embodiment of the present disclosure.

FIG. 2 is a flowchart illustrating a method for calculating carbon emissions of a DRAM product according to an embodiment of the present disclosure.

FIG. 3 is a flowchart illustrating a method for calculating carbon emissions of a NAND product according to an embodiment of the present disclosure.

FIG. 4 is a diagram illustrating a data sheet specification of a DRAM product (DDR4) according to an embodiment of the present disclosure.

FIG. 5 is a diagram illustrating a data sheet specification of a DRAM product (DDR5) according to an embodiment of the present disclosure.

FIG. 6 is a diagram illustrating the Data sheet spec of a NAND product (eSSD 72-layer) according to an embodiment of the present disclosure.

FIG. 7 is a diagram illustrating the Data sheet spec of a NAND product (eSSD 96-layer, 128-layer) according to an embodiment of the present disclosure.

### DETAILED DESCRIPTION

Since the present disclosure may be changed in various ways and have various forms, specific aspects or embodiments thereof will be described in detail herein. However, this is not intended to limit the present disclosure to a specific embodiment, and instead the present disclosure is to be understood as including all modifications, equivalents, or substitutes that fall within the spirit and scope of the present disclosure.

The terminology used herein is for the purpose of describing particular aspects or embodiments only and is not intended to be limiting. In the present disclosure, the singular forms are intended to include the plural forms as well, unless the context clearly indicates otherwise. It will be further understood that the terms “comprise”, “include”, etc. when used herein, specify the presence of stated features, integers, steps, operations, elements, components, and/or combinations of them but do not preclude the possibility of the presence or addition of one or more other features, integers, steps, operations, elements, components, and/or combinations thereof.

Unless otherwise defined, all terms including technical and scientific terms used herein have the same meaning as commonly understood by one of ordinary skill in the art to which the present disclosure belongs. Terms defined in commonly used dictionaries should be should be interpreted as having a meaning that is consistent with their meaning in the context of the relevant art and will not be interpreted in an idealized or overly formal sense unless expressly so defined herein.

The terms “first,” “second,” etc., described herein are only used to distinguish one component from another component, and are not limited by the manufacturing order. The names may not be consistent in the detailed description of the present disclosure and the claims.

The present disclosure relates to a method (hereinafter referred to as “this method”) for calculating carbon emissions according to the amount of power consumption of a semiconductor product using the data sheet specifications, and proposes a technology for quantitatively calculating the amount of reduction in power consumption resulting from performance improvement and manufacturing process advancement of certain DRAM and NAND semiconductor products, and converting the results into carbon emissions to compare and evaluate environmental impacts from different semiconductor products.

A baseline product refers to a conventional product, while an improved-performance product refers to a technologically advanced product that offers improved performance over the baseline product. The present disclosure provides a method to quantify the environmental benefits of transitioning from a baseline product to an improved-performance product. Hereinafter, this method will be described in detail with reference to the accompanying drawings.

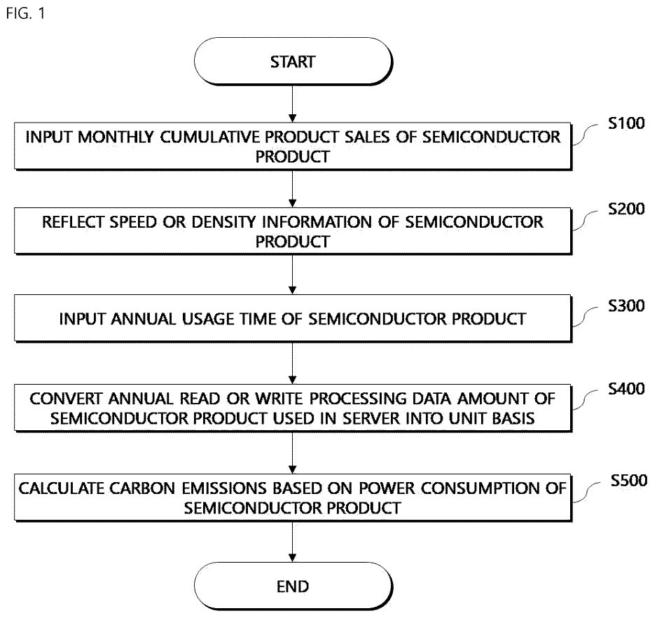

FIG. 1 is a flowchart illustrating a method for calculating carbon emissions of a semiconductor product according to an embodiment of the present disclosure.

As shown in FIG. 1, a method for calculating carbon emissions of a semiconductor product may include step S100 of inputting monthly cumulative product sales of the semiconductor product, step S200 of reflecting speed or density information of the semiconductor product, step S300 of inputting annual usage time of the semiconductor product, step S400 of converting an annual read or write processing data amount of the semiconductor product used in a server into a unit basis, and step S500 of calculating carbon emissions based on power consumption of the semiconductor product.

Prior to step S100 of inputting the monthly cumulative product sales of the semiconductor product, the method may further include step S50 (not illustrated) of loading specification data of the semiconductor product.

The specification data of the semiconductor product is found in the data sheet specifications provided by a semiconductor manufacturer, and preferably includes product characteristics, test conditions for use, density, I/O, operating speed, operating voltage, power consumption, DWPD (Drive Writes Per Day), etc.

Herein, calculations of such as power consumption and carbon emissions are performed by reflecting contents described in the specification data of each semiconductor product.

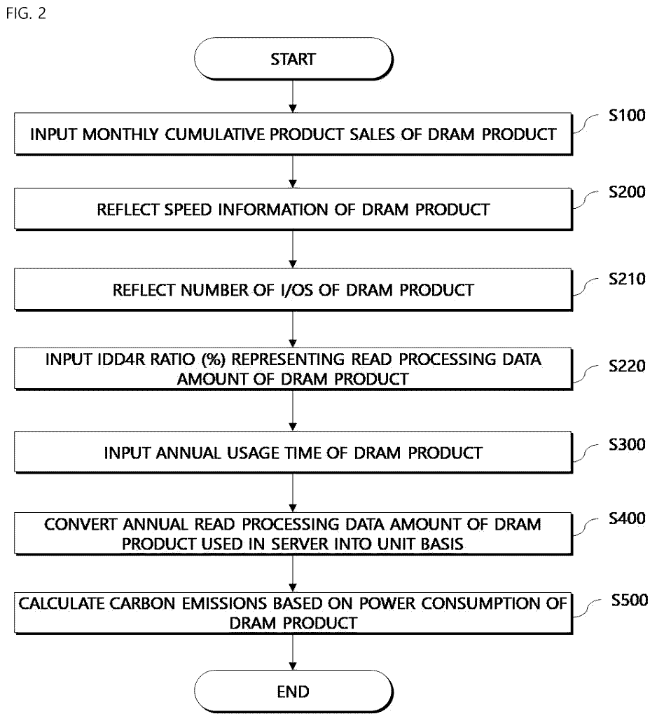

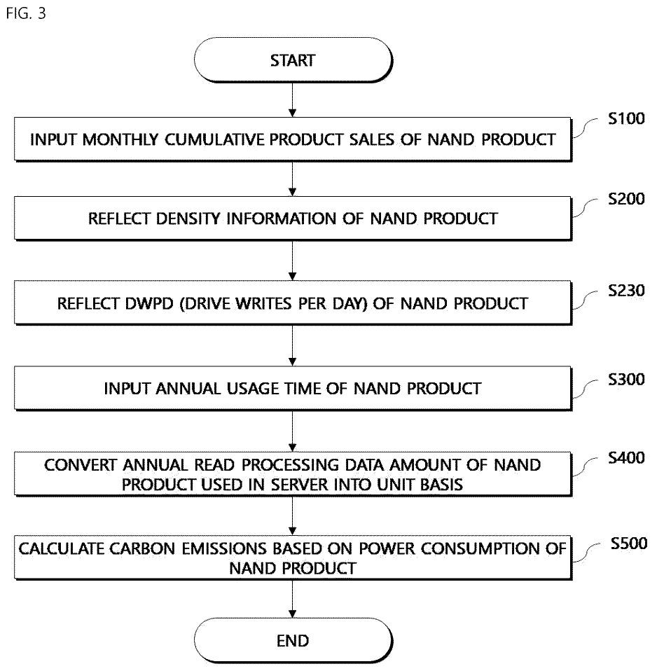

Before explaining the present disclosure in detail, it is to be noted that exemplary semiconductor products include DRAM and NAND products, and there are step differences in the method for calculating the carbon emissions for each type of semiconductor product, as shown in FIGS. 2 and 3.

DRAM (Dynamic Random Access Memory) is a high-speed memory used for data storage and processing, and is used in various digital devices such as computers, servers, and graphics cards. DRAM technology is being developed to improve speed (bandwidth), power efficiency, and space efficiency.

Types of DRAM include DDR4, GDDR5, and HBM. DDR4 is a form in which a single DRAM die is mounted on a substrate and is mainly used in servers and PCs. GDDR5 is a memory based on a single DRAM die that uses IFBGA technology to further increase speed, and is mainly used in graphics cards and game consoles that require high-speed data processing. HBM is a form in which several DRAM core dies are stacked using TSV (Through-Silicon Via) technology. It offers advantages in bandwidth, power efficiency, and space utilization, and is used in high-performance computing, data centers, and advanced graphics cards.

FIG. 2 is a flowchart illustrating a method for calculating carbon emissions of a DRAM product according to an embodiment of the present disclosure.

Referring to FIG. 2, prior to step S300 of inputting the annual usage time of a DRAM semiconductor product, the method includes step S210 of reflecting the number of I/Os of the DRAM product and step S220 of inputting the IDD4R ratio (%) representing the read processing data amount of the DRAM product.

Hereinafter, each step of the present disclosure will be described in detail. In step S100, inputting the monthly cumulative product sales of the DRAM product includes inputting the cumulative quantity of the DRAM products sold on a monthly basis, and serves as an initial input value for calculating an annual data processing volume based on the actual usage of the DRAM product. Step S100 may also include inputting the number of I/Os (Input/Output) of the DRAM product, and the number of I/Os is a factor that directly affects the data processing volume of the DRAM.

In step S200, reflecting the speed information of the DRAM product includes reflecting the operating speed information of the DRAM product. The operating speed represents the data processing performance and is preferably expressed in terms of bandwidth (Gbps).

In step S220, the read processing data amount (IDD4R) ratio (%) of the DRAM is input. IDD4R represents the power consumed during a read operation of the DRAM and indicates the proportion of the read operation within a total data processing volume, expressed as a percentage. The IDD4R ratio value entered in this step may be input by referring to the value specified and provided in the data sheet specifications of the corresponding DRAM product.

Further, step S300 of inputting the annual usage time of the DRAM product includes entering how much the DRAM product is used annually in hours. Since DRAM products are used 24 hours a day throughout the year in environments such as data centers, usage is generally set by converting this usage into hours for input.

In step S400, converting the annual read processing data amount of the semiconductor product used in the server into a unit basis includes calculating the annual read processing data amount of the DRAM product based on the data entered above.

It is preferable to calculate the annual read processing data amount by multiplying the monthly cumulative product sales, speed information, number of I/Os, and IDD4R ratio of the DRAM product by a time conversion value for calculating the annual data processing volume. In the present disclosure, 364 days corresponding to 52 weeks are used in calculating the annual data processing volume, and a processing volume per second (Gb/s) is converted into the annual read processing data amount by multiplying 3,600 (seconds/hour)×24 (hours/day)×364 (days/year).

Next, step S500 of calculating the carbon emissions based on the power consumption of the DRAM product may be performed based on the power consumption (pJ/bit) of the DRAM product. The power consumption (pJ/bit) of the DRAM product may be calculated using the following Equation 1.

EU_{BL,i,j}=(IDDᵢⱼ×VDD+IDDQᵢⱼ×VDDQ+IPP_{i,j}×VPP)÷(DRᵢ×IOᵢ) [Equation 1]

The step of calculating the power consumption (EU_{BL,i,j}, pJ/bit) of the DRAM product may include step S510 (not illustrated) of reflecting the IDD power consumption, IDDQ power consumption, and IPP power consumption in a specific mode of the DRAM product, step S520 (not illustrated) of calculating the sum of power consumption by multiplying the IDD power consumption by the VDD operating voltage, the IDDQ power consumption by the VDDQ operating voltage, and the IPP power consumption by the VPP operating voltage, and step S530 (not illustrated) of calculating the power consumption (pJ/bit) by dividing the sum of power consumption by the operating speed and number of I/Os of the DRAM product.

The carbon emissions of the DRAM product can be calculated using the following Equation 2.

$${BE}_{y} = {\sum }_{k} {\sum }_{i} {\sum }_{j} ( {n}_{k , i , y} \times {ρ}_{PJ , i , j , y} \times {o}_{i , y} \times {EU}_{BL , i , j} \times {EF}_{grid , k} ) \qquad [ Equation 2 ]$$

In Equation 2, BE_{y} represents the carbon emissions, n_{k,i,y} represents the sales, p_{PJ,i,j,y} represents the data amount, o_{i,y} represents the annual usage time, EU_{BL,i,j} represents the power consumption, and EF_{grid,k} represents the international standard emission factor.

In the carbon emission calculation step S500, it is preferable to use the international standard emission factor (tCO₂-eq/MWh) to convert the power consumption of the semiconductor product into carbon emissions (tCO₂-eq).

By using the carbon emissions of each semiconductor product, it is possible to evaluate the power consumption reduction effect resulting from technological advancements, namely design and manufacturing process advancements of semiconductor products, thereby comparing the impacts to carbon emission reduction among different semiconductor products.

It is preferable to calculate the carbon emission reduction of a DRAM product by subtracting, from baseline product emissions, the improved-performance product in the form of reduced product emissions and leakage emissions. Here, the leakage emissions refer to unintentionally increased greenhouse gas emissions other than the emissions of the improved-performance product.

Hereinafter, the present disclosure will be described in more detail through Examples. However, the following embodiments are merely illustrative of the present disclosure, and the scope of the present disclosure is not limited to the following embodiments.

### Example 1

### Comparison of Power Consumption Reduction and Carbon Emission Reduction Between DDR4 and DDR5

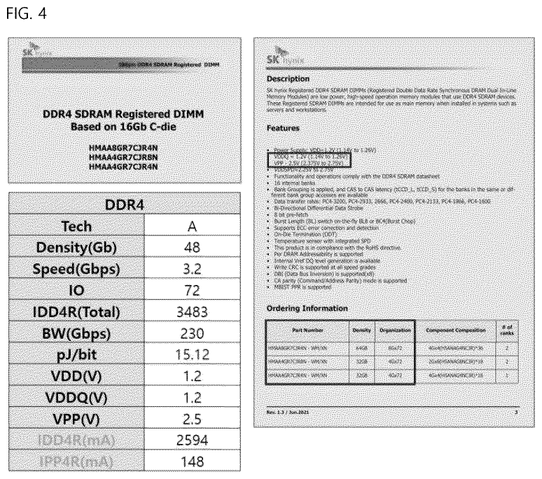

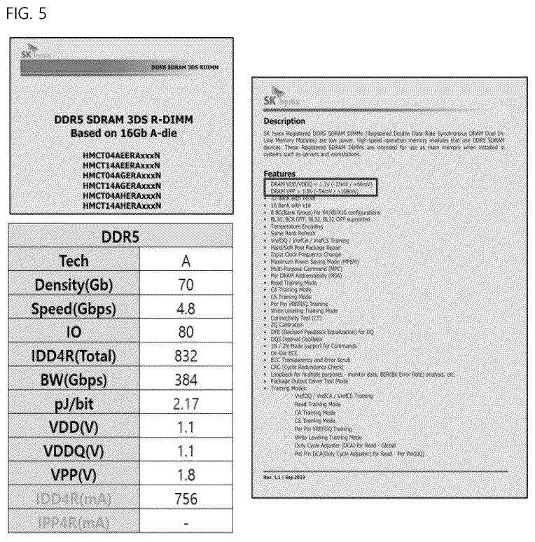

FIG. 4 is a diagram illustrating a data sheet specification of a DRAM product (DDR4) according to an embodiment of the present disclosure, and FIG. 5 is a diagram illustrating data sheet specifications of a DRAM product (DDR5) according to an embodiment of the present disclosure.

The results of calculating the power consumption (pJ/bit) for each product using the Data sheet spec of DDR4 and DDR5 are shown in Table 1.

In FIGS. 4 and 5, DDR4 is the baseline product, and DDR5 is the improved-performance product. Compared to DDR4, DDR5 features a lower operating voltage (VDD), reduced from 1.2V to 1.1V, which results in lower basic power consumption. Furthermore, the IDD4R of DDR5 is 832 mA, representing an approximately 76% reduction from the 3,483 mA of DDR4.

TABLE 1

| DRAM- | | Density | Speed | | IDD4R | BW | VDD | VDDQ | VPP | IDD4R | IPP4R | |
|---|---|---|---|---|---|---|---|---|---|---|---|---|
| Type | Tech | (Gb) | (Gbps) | I/O | (Total) | (Gbps) | (V) | (V) | (V) | (mA) | (mA) | pJ/bit |
| DDR4 | A | 48 | 3.2 | 72 | 3483 | 230 | 1.2 | 1.2 | 2.5 | 2594 | 148 | 15.12 |
| DDR5 | A | 70 | 4.8 | 80 | 832 | 384 | 1.1 | 1.1 | 1.8 | 756 | — | 2.17 |

As shown in Table 1, it can be seen that the power consumption decreased from 15.12 pJ/bit for DDR4 to 2.17 pJ/bit for DDR5. For context, the annual data throughput, which is a basis for this calculation, was determined by multiplying factors such as cumulative monthly product sales, speed information, the number of I/Os, and the IDD4R ratio by a time conversion value. This annual time conversion value is derived from 3,600 (sec/hour)×24 (hours/day)×364 (days/year).

The results of calculating the carbon emission reduction by multiplying sales, data amount, annual usage time, and the international standard emission factor based on the above power consumption (pJ/bit) are shown in Table 2. In Embodiment 1, it is assumed that there are no leakage emissions and that the baseline product and the improved-performance product have the same annual data throughput, in order to compare only the direct difference in power consumption between the baseline product and the improved-performance product.

TABLE 2
(Unit: tCO₂-eq)

| Baseline product | Improved-performance | | Carbon |
|---|---|---|---|
| emissions | product emissions | Leakage | emission |
| (DDR4) | (DDR5) | emissions | reduction |
| 91,220 tCO₂-eq. | 13,079 tCO₂-eq. | — | 78,140 tCO₂-eq. |

Tables 1 and 2 confirm that the technological advancements of the semiconductor product, along with improvements in design and manufacturing processes, leads to power consumption reduction and carbon emission reduction.

### Example 2

### Comparison of Power Consumption Reduction and Carbon Emission Reduction Between GDDR5 and HBM2/HBM2E

The results of calculating the power consumption (pJ/bit) for each product using the data sheet specifications of DRAMs, such as GDDR5, HBM2, and HBM2E are shown in Table 3.

In Table 3, GDDR5 is the baseline product, and HBM2/HBM2E are the improved-performance products. GDDR5 has a planar structure in which a single DRAM die is mounted on a substrate, whereas HBM (High Bandwidth Memory) features a 3D structure where multiple DRAM dies are vertically stacked using Through-Silicon Via (TSV) technology. This 3D stacked structure shortens the data travel path and enables a wide 1024-bit I/O interface. Consequently, HBM products can achieve higher bandwidth than GDDR5 even at significantly lower operating speeds, resulting in lower power consumption per data bit.

TABLE 3

| | | IDD | IDDQ | IPP | Speed | |
|---|---|---|---|---|---|---|
| DRAM | Type | (Core) | (Controller) | (Pump) | (Gbps) | I/O |
| GDDR5 | mA | 1050 | 0 | 0 | | |
| 8 GB | V | 1.5 | 1.5 | 0 | | |
| | IDD4R(mW) | 1575 | 0 | 0 | 8 | 32 |
| | power | 6.152 (=1575/8/32) | | | | |
| | consumption(pJ/bit) | | | | | |
| HBM2 | mA | 6580 | 2660 | 320 | | |
| 8 GB | V | 1.2 | 1.2 | 2.5 | | |
| | IDD4R(mW) | 7896 | 3192 | 800 | 2 | 1024 |
| | power | 5.805 [=(7896 + 3192 + 800)/2/1024] | | | | |
| | consumption(pJ/bit) | | | | | |
| HBM2E | mA | 8110 | 3650 | 280 | | |
| 8 GB | V | 1.2 | 1.2 | 2.5 | | |
| | IDD4R(mW) | 9732 | 4380 | 700 | 3.2 | 1024 |
| | power | 4.520 [=(9732 + 4380 + 700)/3.2/1024] | | | | |
| | consumption(pJ/bit) | | | | | |

As shown in Table 3, it can be seen that the power consumption decreases sequentially from 6.152 pJ/bit for GDDR5, to 5.805 pJ/bit for HBM2, and to 4.520 pJ/bit for HBM2E. Here, the power consumption per bit (pJ/bit) for each DRAM is calculated by dividing the total power consumption (mW) by the total data throughput (Gbps×I/O). Specifically, whereas GDDR5 considers only the power consumption of the IDD (Core), HBM2 and HBM2E calculate the total power consumption by summing the power consumptions of the IDD (Core), IDDQ (Controller), and IPP (Pump).

The results of calculating the carbon emission reduction by multiplying sales, annual usage time, and the international standard emission factor based on the above power consumption (pJ/bit) are shown in Table 4. In Embodiment 2, it is assumed that there are no leakage emissions and that the baseline product and the improved-performance product have the same annual data throughput, in order to compare only the direct difference in power consumption between the baseline product and the improved-performance product.

TABLE 4

| Baseline- | Improved- | | |
|---|---|---|---|
| product | performance- | | Carbon- |
| emissions | product emissions | Leakage | emission- |
| (GDDR5) | (HBM2/HBM2E) | emissions | reduction |
| 134,665 tCO₂-eq. | 104,641 tCO₂-eq. | — | 30,024 tCO₂-eq. |

Tables 3 and 4 confirm that the technological advancement of the semiconductor product, along with improvements in design and manufacturing processes, leads to power consumption reduction and carbon emission reduction.

Next, NAND flash memory is a type of non-volatile memory that can store data permanently. It retains data even when power is turned off and provides fast read/write speeds and high durability, so it is used in SSDs, USBs, and memory cards.

There are 2D NAND and 3D NAND structures. The 2D NAND structure has cells arranged horizontally on a flat surface, which makes the manufacturing process simple but has limitations in capacity expansion. On the other hand, the 3D NAND structure is a stacked structure in which the cells are vertically layered, providing excellent advantages such as efficient space utilization, higher storage capacity, improved power efficiency, and enhanced write performance.

FIG. 3 is a flowchart illustrating a method for calculating carbon emissions of a NAND product according to an embodiment of the present disclosure. Steps identical to those in FIG. 2 are substantially similar and a description will not be repeated with respect to FIG. 3.

Referring to FIG. 3, when NAND products are used, step S230 of reflecting DWPD (Drive Write Per Day), which indicates how many times the drive can be completely written per day during a warranty period, is further included prior to step S300 of inputting the annual usage time of the semiconductor product.

Unlike the DRAM product, the method for calculating carbon emissions for NAND products includes steps such as reflecting density information instead of speed information and reflecting DWPD, resulting in step differences.

In step S400 of converting the annual write processing data amount of the semiconductor product used in the server into the unit basis is a step of performing calculation by multiplying the monthly cumulative product sales, density information, and DWPD of the NAND product by a time conversion value for calculating the annual data processing volume. In the present disclosure, one year is assumed to be 364 days, corresponding to 52 weeks, and the annual write data amount (Gb/year) is calculated by multiplying 364 (days/year) as the time conversion value.

Next, step S500 of calculating carbon emissions based on the power consumption of the NAND product may be performed based on the power consumption (J/GB) of the NAND product. At this time, the power consumption (J/GB) of the NAND product may be calculated using the following Equation 3.

EU_{BL,i}=(PW_{BL,i}=MSW_{BL,i}) [Equation 3]

The step of calculating the power consumption (EU_{BL,i}, J/GB) of the NAND product may include step S540 (not illustrated) of reflecting the write power consumption (PW_{BL,i}, W) of the NAND product, and step S550 of calculating the power consumption (J/GB) by dividing the reflected write power consumption by the sequential write performance (MSW_{BL,i}, GB/s) of the NAND product.

The carbon emissions of the NAND product may be calculated using the following Equation 4.

$${BE}_{y} = {\sum }_{k} {\sum }_{i} ( {n}_{k , i , y} \times {ρ}_{PJ , i , y} \times {EU}_{BL , i} \times {EF}_{grid , k} ) \qquad [ Equation 4 ]$$

In Equation 4, BE_{y} represents the carbon emissions, n_{k,i,y} represents the sales, p_{PJ,i,j,y} represents the data amount, EU_{BL,i} represents the power consumption, and EF_{grid,k} represents the international standard emission factor.

In the carbon emission calculation step S500, it is preferable to use the international standard emission factor (tCO₂-eq/MWh) to convert the power consumption of the semiconductor product into carbon emissions (tCO₂-eq).

By comparing the carbon emissions of each semiconductor product, it is possible to evaluate the power consumption reduction effect resulting from technological advancements, and design and manufacturing process advancements of the semiconductor product, thereby comparing the carbon emission reduction.

It is preferable to calculate the carbon emission reduction of the NAND product by subtracting improved-performance product emissions and leakage emissions from baseline product emissions. Here, the leakage emissions refer to unintentionally increased greenhouse gas emissions other than the emissions of the improved-performance product.

Hereinafter, the present disclosure will be described in more detail through embodiments. However, the following embodiments are merely illustrative of the present disclosure, and the scope of the present disclosure is not limited to the following embodiments.

### Example 3

Comparison of Power Consumption Reduction and Carbon Emission Reduction Between eSSD (72-Layer) and eSSD (96-Layer, 128-Layer)

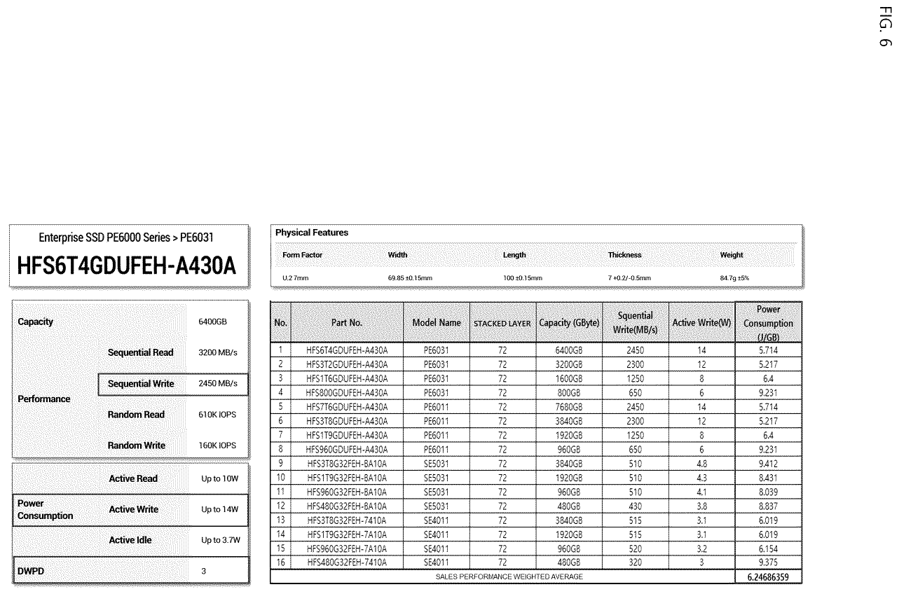

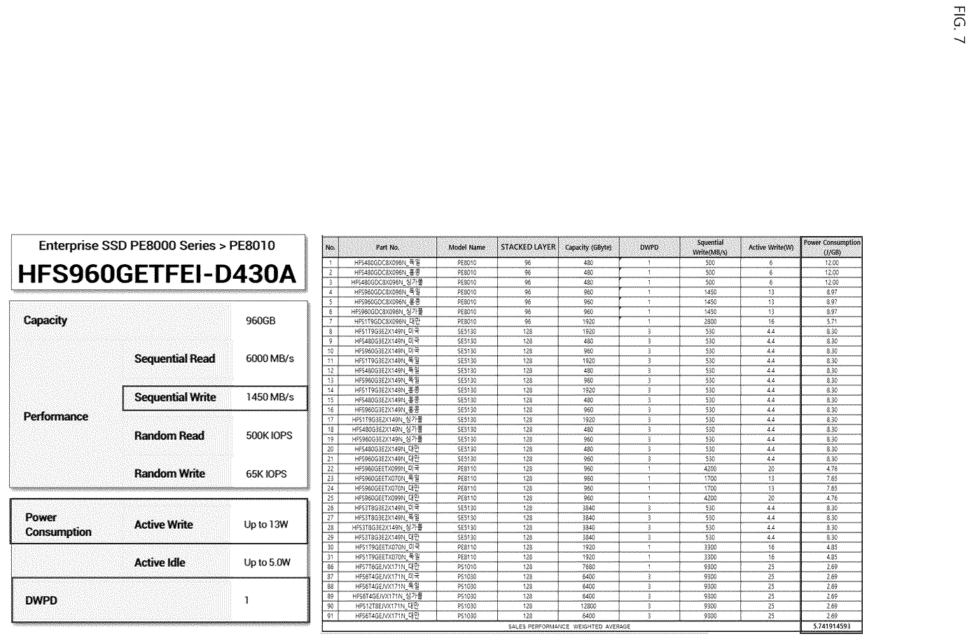

FIG. 6 is a diagram illustrating a data sheet specification of a NAND product (eSSD 72-layer) according to an embodiment of the present disclosure, and FIG. 7 is a diagram illustrating a data sheet specification of a NAND product (eSSD 96-layer, 128-layer) according to an embodiment of the present disclosure.

The average values of power consumption (J/GB) for each product, calculated using the Data sheet specs of eSSD 72-layer, 96-layer, and 128-layer, are shown in Table 5.

In this following description, the eSSD 72-layer is the baseline product, and the eSSD 96-layer and 128-layer are the improved-performance products.

TABLE 5

| NAND | Sequential | Active | | |
|---|---|---|---|---|
| product- | Write | Write | | J/GB |
| type | (MB/s) | (W) | DWPD | (Avg.) |
| eSSD(72- | 2540 | 14 | 3 | 6.25 |
| layer) | | | | |
| eSSD(96- | 1450 | 13 | 1 | 5.74 |
| layer, | | | | |
| 128- | | | | |
| layer) | | | | |

As shown in Table 5, it can be seen that the average values of power consumption decreased from 6.25 J/GB for the eSSD 72-layer to 5.74 J/GB for the eSSD 96-layer and 128-layer.

The results of calculating the carbon emission reduction by multiplying sales, data amount, and an international standard emission factor based on the above power consumption (J/GB) are shown in Table 6. In Embodiment 3, it is assumed that there are no leakage emissions in order to compare only the direct difference in power consumption between the baseline product and the improved-performance product.

TABLE 6
(Unit: tCO₂-eq)

| Baseline-product | | | Carbon- |
|---|---|---|---|
| emissions | Improved-performance | Leakage | emission |
| (eSSD 72-layer) | product emissions | emissions | reduction |
| 116,646 | eSSD 96-layer: 76,910 | — | 39,736 |
| 140,113 | eSSD 128-layer: 113,533 | — | 26,580 |

Tables 5 and 6 confirm that the technological advancements of the semiconductor product, along with improvements in design and manufacturing processes, lead to power consumption reduction and carbon emission reduction.

According to an aspect of the present disclosure, the process may be split into additional steps or combined into fewer steps. Also, some steps may be omitted as needed, and the order of the steps may be changed.

The present disclosure described above with reference to the accompanying drawings can be modified and changed in various ways by those skilled in the art, and such modifications and changes that are not limited by the claims should be interpreted as being included within the scope of the present disclosure.

What is claimed is:

1. A method for calculating carbon emissions based on power consumption reduction of a semiconductor product, the method comprising:
inputting monthly cumulative product sales of a semiconductor product;
reflecting speed or density information of the semiconductor product;
inputting annual usage time of the semiconductor product;
converting an annual read or write processing data amount of the semiconductor product used in a server into a unit basis; and
calculating carbon emissions based on power consumption of the semiconductor product.

2. The method according to claim 1, further comprising:
when the semiconductor product is a DRAM product,
reflecting a number of I/Os of the DRAM product; and
inputting a ratio of a read processing data amount (IDD4R) of the DRAM product.

3. The method according to claim 1, further comprising:
when the semiconductor product is a NAND product, reflecting DWPD (Drive Writes Per Day) of the NAND product.

4. The method according to claim 2, wherein the converting of the annual read processing data amount of the semiconductor product used in the server into the unit basis performs calculation by multiplying monthly cumulative product sales, speed information, number of I/Os, and IDD4R ratio of the DRAM product by a time conversion value for calculating annual data processing volume.

5. The method according to claim 3, wherein the converting of the annual write processing data amount of the semiconductor product used in the server into the unit basis performs calculation by multiplying monthly cumulative product sales, density information, and DWPD of the NAND product by a time conversion value for calculating annual data processing volume.

6. The method according to claim 4, wherein:
when calculating the carbon emissions of the DRAM product, calculation is based on power consumption (pJ/bit) of the DRAM product, and
the calculating of the power consumption (pJ/bit) of the DRAM product comprises:
reflecting IDD power consumption, IDDQ power consumption, and IPP power consumption in a specific mode of the DRAM product;
calculating a sum of power consumption by multiplying the IDD power consumption by VDD operating voltage, the IDDQ power consumption by VDDQ operating voltage, and the IPP power consumption by VPP operating voltage; and
calculating the power consumption (pJ/bit) by dividing the sum of the power consumption by the operating speed and number of I/Os of the DRAM product.

7. The method according to claim 5, wherein:
when calculating the carbon emissions of the NAND product, calculation is based on power consumption (J/GB) of the NAND product, and
the calculating of the power consumption (J/GB) of the NAND product comprises:
reflecting write power consumption of the NAND product; and
calculating the power consumption (J/GB) by dividing the reflected write power consumption by sequential write performance of the NAND product.

8. The method according to claim 2, wherein carbon emission reduction of the DRAM product is calculated by subtracting improved-performance product emissions and leakage emissions from baseline product emissions.

9. The method according to claim 3, wherein the carbon emission reduction of the NAND product is calculated by subtracting improved-performance product emissions and leakage emissions from baseline product emissions.

10. The method according to claim 8, wherein when the baseline product is GDDR5 or DDR4, the improved-performance product uses HBM2/HBM2E or DDR5.

11. The method according to claim 9, wherein when the baseline product is 72-layered eSSD, the improved-performance product uses 96-layered eSSD or 128-layered eSSD.

12. The method according to claim 1, further comprising:
loading specification data of the semiconductor product, prior to the inputting of the monthly cumulative product sales,
wherein the specification data of the semiconductor product comprises product characteristics, usage test conditions, density, number of I/Os, operating speed, operating voltage, power consumption, and DWPD.

13. The method according to claim 1, wherein in the calculating of the carbon emissions, an international standard emission factor (tCO₂-eq/MWh) is used to convert the power consumption of the semiconductor product into carbon emissions (tCO₂-eq).
